(19) United States
(12) Patent Application Publication
(10) Pub. No.: US 2010/0134513 A1
(43) Pub. Date: Jun. 3, 2010

(54) PIXEL DISPLAY DEVICE

(75) Inventor: Hirokatsu YUI, Osaka (JP)

Correspondence Address: RATNERPRESTIA, P.O. BOX 980, VALLEY FORGE, PA, 19482, US

(73) Assignee: Panasonic Corporation, Kadoma-shi (JP)

(21) Appl. No.: 12/623,716

(22) Filed: Nov. 23, 2009

(30) Foreign Application Priority Data
Dec. 3, 2008 (JP) 2008-308165

(51) Int. Cl. G09G 5/02; G09G 5/00

(52) U.S. Cl. 345/589; 345/660

(57) ABSTRACT

A pixel display device includes a decoding unit for decoding an image signal, a first storage unit for storing the image signal decoded, a second storage unit for storing the image signal whose aspect ratio has been converted, and a control unit. The control unit initializes the second storage unit by storing image data having a predetermined color tone therein, and divides the image signal stored in the first storage unit into a predetermined number of regions corresponding to the number of display pixels of a display screen. The control unit subjects the image signal stored in the first storage unit to an enlarging process, based on horizontal/vertical magnification information indicating the different magnification factors of the different divided regions in at least one of the horizontal and vertical directions, and stores the image signal subjected to the enlarging process in the corresponding regions of the second storage unit.

### BACKGROUND OF THE INVENTION

1. Field of the Invention

The present invention relates to a pixel display device. More particularly, the invention relates to a pixel display device in which when a display screen, that is, a display element has a large aspect ratio difference, an image shown on the display element and distortion in the field of view are divided into small independent regions so as to change the magnification factors of the image in the horizontal and vertical directions.

2. Background Art

Conventional pixel display devices include an image magnifying circuit. This circuit allows, when a received image signal and a display element for displaying images thereon have different aspect ratios from each other, the received image signal to be expanded or contracted and hence to be displayed on the entire displayable area of the display element.

The concept of enlarging and displaying images in the conventional pixel display devices will be described with reference to FIGS. 10A and 10B. FIG. 10A is a conceptual view of an example in which an image is enlarged and displayed after being divided uniformly both in the horizontal and vertical directions of the display element. FIG. 10B is a conceptual view of an example in which an image is enlarged and displayed after being divided nonuniformly both in the horizontal and vertical directions of the display element.

As disclosed in, for example, Japanese Patent Unexamined Publications Nos. H11-073154 and 2002-064760, in the conventional pixel display devices, an image is divided into some regions as shown in FIGS. 10A and 10B so as to minimize distortion of the image when it is extended on the display element. More specifically, the image is divided horizontally into some regions in such a manner that each of these regions has its own horizontal magnification factor, and is also divided vertically into some regions in such a manner that each of these regions has its own vertical magnification factor.

As a result, in the example of FIG. 10B, the horizontally adjacent regions have the same vertical magnification factor, and the vertically adjacent regions have the same horizontal magnification factor.

In this conventional structure, when the display element has a small aspect ratio difference as in the case of 16:9 with respect to the original image, the obtained image looks natural because the image distortions can be minimized. When the display element has a large aspect ratio difference as in the case of 30:9 with respect to the original image, however, the obtained image looks unnatural because some image distortions are large. These large distortions are caused by the difference between the horizontal and vertical magnification factors due to the aspect ratio difference.

### SUMMARY OF THE INVENTION

The pixel display device according to the present invention for displaying an image signal after converting its aspect ratio includes a decoding unit, a first storage unit, a second storage unit, and a control unit. The decoding unit decodes the image signal. The first storage unit stores the image signal decoded. The second storage unit stores the image signal whose aspect ratio has been converted. The control unit initializes the second storage unit by storing image data having a predetermined color tone therein, and divides the image signal stored in the first storage unit into a predetermined number of regions, the predetermined number corresponding to the number of display pixels of a display screen. The control unit then subjects the image signal stored in the first storage unit to an enlarging process from region to region, based on horizontal/vertical magnification information indicating different magnification factors of different divided regions in at least one of the horizontal and vertical directions. The control unit then stores the image signal subjected to the enlarging process from region to region in the corresponding regions of the second storage unit.

### BRIEF DESCRIPTION OF THE DRAWINGS

FIG. 1 is a circuit block diagram of a pixel display device according to a first embodiment of the present invention.

FIG. 2A is a conceptual view showing horizontal/vertical magnification information in the first embodiment.

FIG. 2B is another conceptual view showing the horizontal/vertical magnification information in the first embodiment.

FIG. 2C is a further another conceptual view showing the horizontal/vertical magnification information in the first embodiment.

FIG. 3 is a conceptual view of an example of enlarging and displaying an image in the first embodiment.

FIG. 4 is a conceptual view of another example of enlarging and displaying an image in the first embodiment.

FIG. 5 is a circuit block diagram of another pixel display device according to the first embodiment.

FIG. 6 is a conceptual view of an example showing the procedure for processing a stereoscopic image signal inputted to the pixel display device of FIG. 5 according to the first embodiment.

FIG. 7 is a conceptual view of another example of the procedure for processing a stereoscopic image signal inputted to the pixel display device of FIG. 5 according to the first embodiment.

FIG. 8 is a circuit block diagram of a pixel display device according to a second embodiment of the present invention.

FIG. 9 shows the relation between genre information contained in an image signal and a method for enlarging and displaying an image in the second embodiment.

FIG. 10A is a conceptual view showing how an image is enlarged and displayed according to a conventional pixel display device.

FIG. 10B is another conceptual view showing how an image is enlarged and displayed according to the conventional pixel display device.

### DETAILED DESCRIPTION OF THE INVENTION

Embodiments of the present invention will be described as follows with reference to drawings.

### First Embodiment

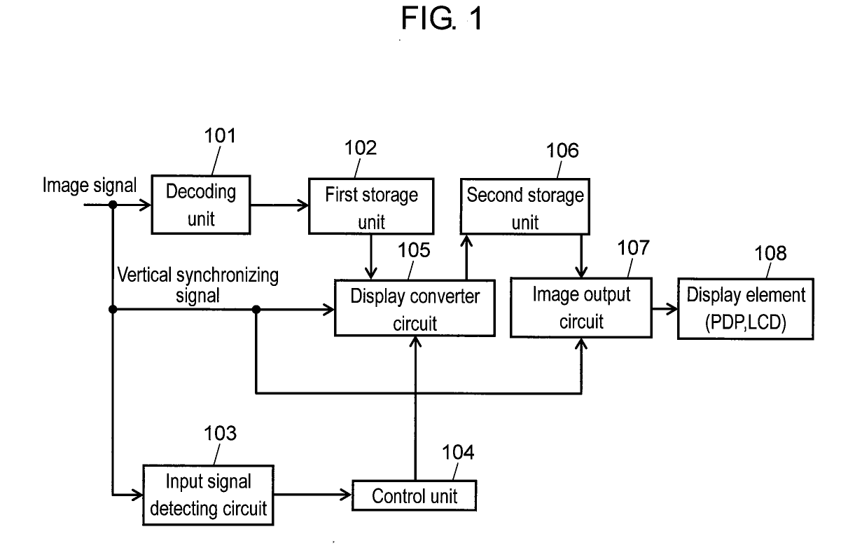

FIG. 1 is a circuit block diagram of a pixel display device according to a first embodiment of the present invention. The pixel display device, which displays a received image signal after converting its aspect ratio, includes decoding unit 101, first storage unit 102, input signal detecting circuit 103, control unit 104, display converter circuit 105, second storage unit 106, image output circuit 107, and display element 108.

Decoding unit 101, which is composed of an A/D converter circuit or the like, decodes an image signal inputted through a receiving unit (not illustrated). First storage unit 102, which is composed of a frame memory, stores the image signal decoded by decoding unit 101. Input signal detecting circuit 103 counts the number of lines of the image signal inputted through the receiving unit from the horizontal and vertical synchronizing signals of the image signal. Input signal detecting circuit 103 then detects the type of the image signal from the number of lines counted. The image signal can be 480i, 1080i, 720p or other types.

Control unit 104 identifies the number of pixels of the image signal from the type of the image signal detected by input signal detecting circuit 103. Control unit 104 then identifies the number of display pixels of display element 108 to be used. Control unit 104 then divides the image signal stored in first storage unit 102 into a predetermined number of regions corresponding to the number of display pixels of the display screen. After these processes, control unit 104 controls display converter circuit 105 in such a manner that the divided regions have predetermined magnification factors, using the identified number of pixels of the image signal and the identified number of display pixels.

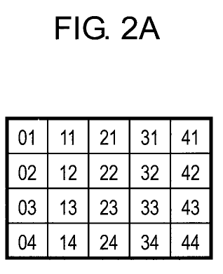

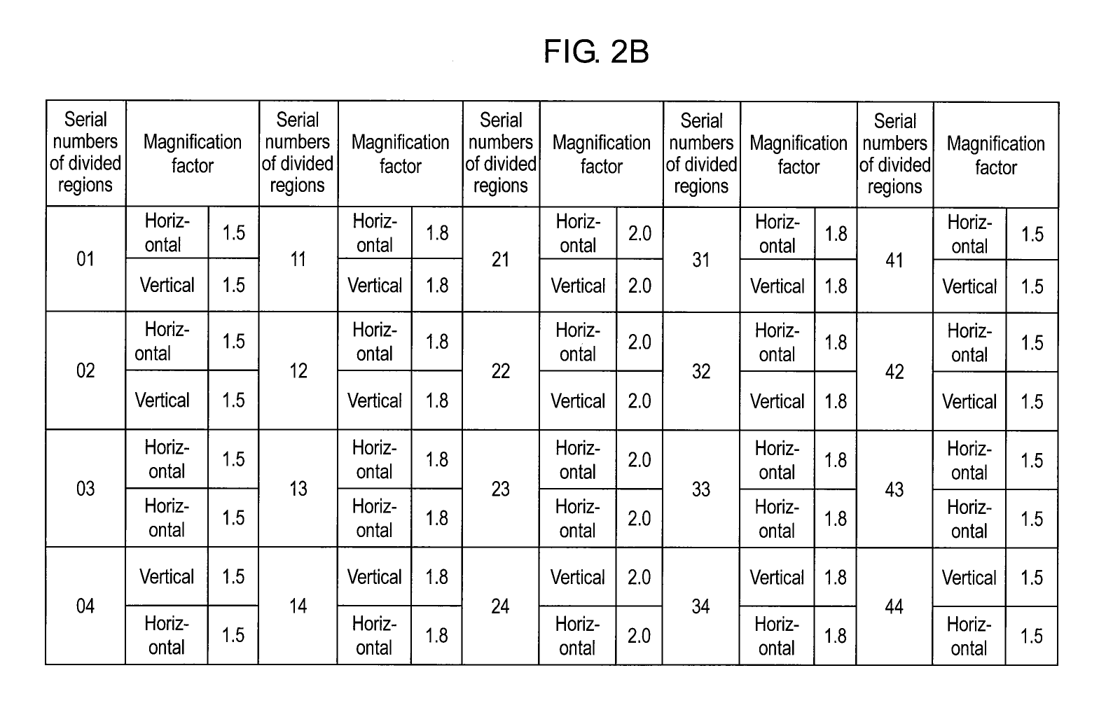

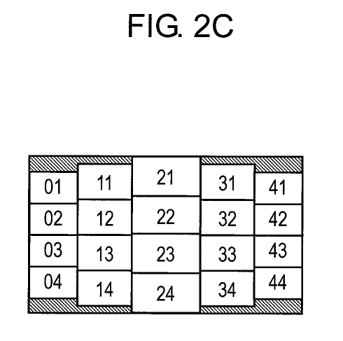

FIGS. 2A, 2B, and 2C are conceptual views showing horizontal/vertical magnification information in the present embodiment. FIG. 2A is a conceptual view of an example in which an image signal stored in first storage unit 102 is divided into a predetermined number of regions. In FIG. 2A, the regions correspond to the regions of a display screen when a received image signal is displayed as it is, and the numerals indicate the divided regions. FIG. 2B shows horizontal magnification factors and vertical magnification factors of the divided regions as an example of the horizontal/vertical magnification information corresponding to the divided regions. FIG. 2C is a conceptual view of an example in which an image signal converted in aspect ratio and stored in second storage unit 106 is divided into a predetermined number of regions. In FIG. 2C, the regions correspond to the regions of the display screen of display element 108, and the numerals indicate the divided regions. The regions indicated by the numerals in FIG. 2C correspond to the regions indicated by the same numerals in FIG. 2A. In FIGS. 2A, 2B, and 2C, the predetermined number is 20 for easier explanation, but is not limited to this number.

As described above, display converter circuit 105 under the control of control unit 104 performs a process of enlarging an image signal stored in first storage unit 102 from region to region based on horizontal/vertical magnification information indicating the different magnification factors of the different divided regions of a received image signal in the horizontal and vertical directions shown, for example, in FIG. 2B. Display converter circuit 105 then stores the image signal that has been subjected to the enlarging process from region to region in the corresponding regions of second storage unit 106.

The term “horizontal/vertical magnification information” indicates different magnification factors of different divided regions in at least one of the horizontal and vertical directions when an image signal stored in first storage unit 102 is divided into a predetermined number of regions corresponding to the number of display pixels of the display screen. It is said above that the horizontal/vertical magnification information indicates the different magnification factors of the different divided regions. This information, however, may alternatively indicate the same magnification factor between adjacent regions as long as the magnification factors increase or decrease contiguously throughout the entire screen. This will be described in detail later.

Second storage unit 106 under the control of control unit 104 stores in the corresponding regions the image signal that has been subjected to the vertically enlarging process from region to region and converted in aspect ratio by display converter circuit 105 based on the horizontal/vertical magnification information. When an image signal in one frame is vertically enlarged and stored in second storage unit 106, image output circuit 107 converts the image signal into an image signal having the same aspect ratio as the screen of display element 108 based on the horizontal/vertical magnification information, and outputs the converted image signal. Display element 108 displays the image signal outputted from image output circuit 107 as an image.

In the pixel display device thus structured, the image signal stored in first storage unit 102 is divided into a predetermined number of regions corresponding to the number of display pixels of display element 108 under the control of control unit 104. Then, an image is read from the divided regions, and an enlarged image is written to the specified regions of second storage unit 106. As a result, image data in the divided regions is displayed in predetermined positions of display element 108 as the image enlarged in the horizontal and vertical directions.

Then, under the control of control unit 104, an image stored in other divided regions of first storage unit 102 is read, the regions in which to write the image enlarged according to the read regions are specified, and the enlarged image is written to second storage unit 106. These processes are applied to all the divided regions so that display element 108 can display an image having different magnification factors from region to region. Furthermore, in an image having different magnification factors from region to region, the starting location of the image can be specified from region to region, allowing the seams in the image can be shifted little by little from region to region.

Different divided regions have different horizontal and vertical magnification factors as described above. Therefore, a large difference in the magnification factor between adjacent regions results in a large difference in the magnification factor in the boundary between the regions. This causes the image to have a large seam distortion, greatly distorting the entire image. This can be prevented, however, by increasing the number of divided regions so as to reduce the difference in the magnification factor between adjacent regions, thereby minimizing the seam distortion of the image between adjacent regions.

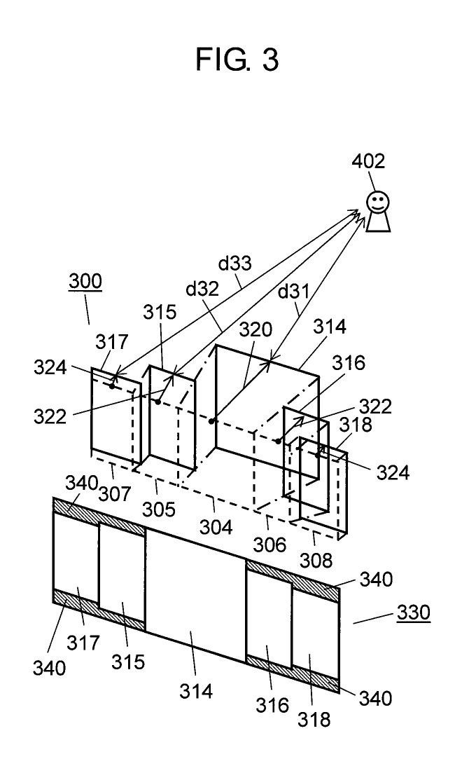

FIG. 3 is a conceptual view of an example of enlarging and displaying an image in the present embodiment. As shown in FIG. 3, in the pixel display device according to the present embodiment, the regions of a received image signal are written to the corresponding regions of second storage unit 106 under the control of control unit 104. In this case, control unit 104 writes the regions of the received image signal to second storage unit 106 based on horizontal/vertical magnification information indicating that the magnification factors are reduced gradually from the center region toward the peripheral regions of the image.

The control of control unit 104 will be described as follows using an example shown in FIG. 3. To show the control of control unit 104 in the present embodiment, FIG. 3 conceptually shows image 300 including an image shown by dotted lines, which is based on a received image signal, and an image shown by solid lines, which is obtained by subjecting the image signal to an enlarging process. Image 300 includes image 330 which has been subjected to an enlarging process and outputted from display element 108.

In FIG. 3, the image consisting of the regions divided based on the received image signal is shown by dotted lines 304, 305, 306, 307, and 308. The image obtained by writing the regions of the received image signal to the corresponding regions of second storage unit 106 based on the horizontal/vertical magnification information is shown by solid lines 314, 315, 316, 317, and 318. Dotted line 304 and solid line 314 show the center region. Dotted line 305 and solid line 315, and dotted line 306 and solid line 316 show the regions on both sides of the center region. Dotted line 307 and solid line 317, and dotted line 308 and solid line 318 show the regions outside the regions.

In this example, the horizontal/vertical magnification information indicates that the magnification factors increase toward the center region of image 330. As a result, as shown by arrows 320, 322, and 324, when viewer 402 views display element 108, the closer the region to the center of image 330, the shorter the distance to viewer 402 looks. In other words, as shown by arrows d31, d32, and d33, objects of image 330 look closer to viewer 402 as they are closer to the center of image 330. This means that the horizontal/vertical magnification information indicates that a received image signal is enlarged in the form of a convex lens. Therefore, the magnification factors of the regions of the received image signal are reduced gradually from the center region toward the peripheral regions, so that display element 108 can display image 330 as if viewer 402 were viewing image 330 through a convex lens from the center of the image.

Display converter circuit 105 under the control of control unit 104 initializes second storage unit 106 by storing black image data indicating the absence of images therein before subjecting image 330 outputted from display element 108 to an enlarging process. This allows display converter circuit 105 to display region 340 containing no images as black images by the enlarging process, making the boundary between regions which have been enlarged and displayed in image 330 almost invisible.

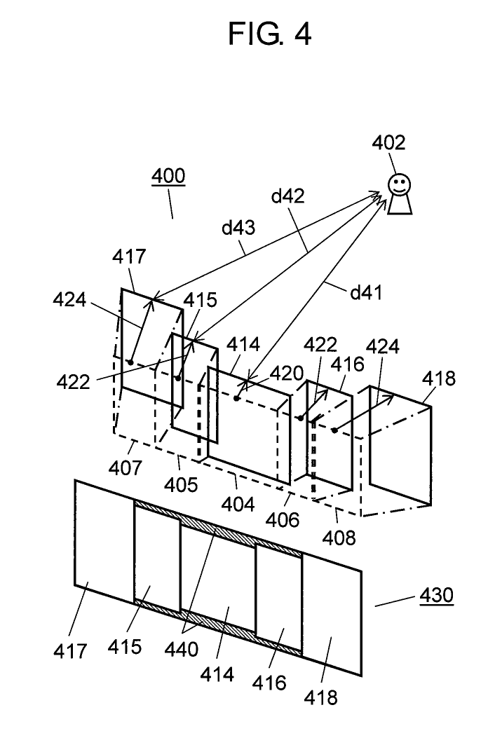

The control of control unit 104 will be described as follows using an example shown in FIG. 4. To show the control of control unit 104 the present embodiment, FIG. 4 conceptually shows image 400 including an image shown by dotted lines, which is based on a received image signal, and an image shown by solid lines, which is obtained by subjecting the image signal to an enlarging process. Image 400 includes image 430 which has been subjected to an enlarging process and outputted from display element 108.

In FIG. 4, the image consisting of the regions divided based on the received image signal is shown by dotted lines 404, 405, 406, 407, and 408. The image obtained by writing the regions of the received image signal to the corresponding regions of second storage unit 106 based on the horizontal/vertical magnification information is shown by solid lines 414, 415, 416, 417, and 418. Dotted line 404 and solid line 414 show the center region. Dotted line 405 and solid line 415, and dotted line 406 and solid line 416 show the regions on both sides of the center region. Dotted line 407 and solid line 417, and dotted line 408 and solid line 418 show the regions outside the regions.

In this example, the horizontal/vertical magnification information indicates that the magnification factors decrease toward the center region of image 430. As a result, as shown by arrows 420, 422, and 424, when viewer 402 views display element 108, the closer the region to the center of image 430, the longer the distance to viewer 402 looks. In other words as shown by arrows d41, d42, and d43, objects of image 430 look further from viewer 402 as they are closer to the center of image 430. This means that the horizontal/vertical magnification information indicates that a received image signal is enlarged in the form of a concave lens. Therefore, the magnification factors of the regions of the received image signal are increased gradually from the center region toward the peripheral regions, so that display element 108 can display image 430 as if viewer 402 were viewing image 430 through a concave lens from the center of the image.

Display converter circuit 105 under the control of control unit 104 initializes second storage unit 106 by storing black image data indicating the absence of images therein before subjecting image 430 outputted from display element 108 to an enlarging process. This allows display converter circuit 105 to display region 440 containing no images as black images by the enlarging process, making the boundary between regions which have been enlarged and displayed in image 430 almost invisible.

The received image signal can be matched to the screen of display element 108 having a different aspect ratio even when the magnification reduction factors of specified regions are different in the horizontal and vertical directions. More specifically, it is possible to control the magnification factors of the specified regions to be different in the horizontal and vertical directions just like the case of enlarging an image through a lens having magnification factors different in the horizontal and vertical directions. This allows display element 108 to display an image containing distortions due to the difference in the magnification factor between the horizontal and vertical directions.

In the present embodiment, each image is illustrated in such a manner as to be enlarged or contracted from its center in the upward, downward, left, and right directions just like the case that the centers of the image and the lens are coincided with each other. Alternatively, display element 108 can display an image just like the case that the lens is placed apart from the center of the lens by enlarging the divided image and displacing the position of the enlarged image.

In the present embodiment, an image is divided first into vertical regions, but may be divided first into horizontal regions.

In the present embodiment, an image is divided first into vertical regions, but may be divided into arbitrary regions in the horizontal and vertical directions. Furthermore, the minimum unit of region may be equivalent to a pixel in an image

When an image is divided into a large number of regions, adjacent regions may have the same horizontal and vertical magnification factors.

When an image is divided into a large number of regions, in a group of regions having a large amount of change in the magnification factor, it is preferable to divide the group into a much larger number of regions so as to make consecutive regions have a smaller amount of change in the magnification factor. More specifically, the number of dividing regions is preferably determined so that the amount of change in the magnification factors of adjacent regions is not more than a predetermined value. For example, the amount of change in the magnification factor of adjacent regions can be set to 10%. This ensures the continuity of an enlarged and displayed image and minimizes the required number of regions.

When second storage unit 106 is initialized before controlling the enlarging process of an image, the absence of images is indicated by black image data, but may be indicated by image data having other predetermined color tones. The predetermined color tones may form a background contained in the image, making the boundary between regions which have been enlarged in the image almost invisible.

In the example of FIG. 2B, an image signal is enlarged in the form of a convex lens according to the horizontal/vertical magnification information. Alternatively, the magnification factors shown in FIG. 2B may have other values such as those which can enlarge the image signal in the form of a concave lens.

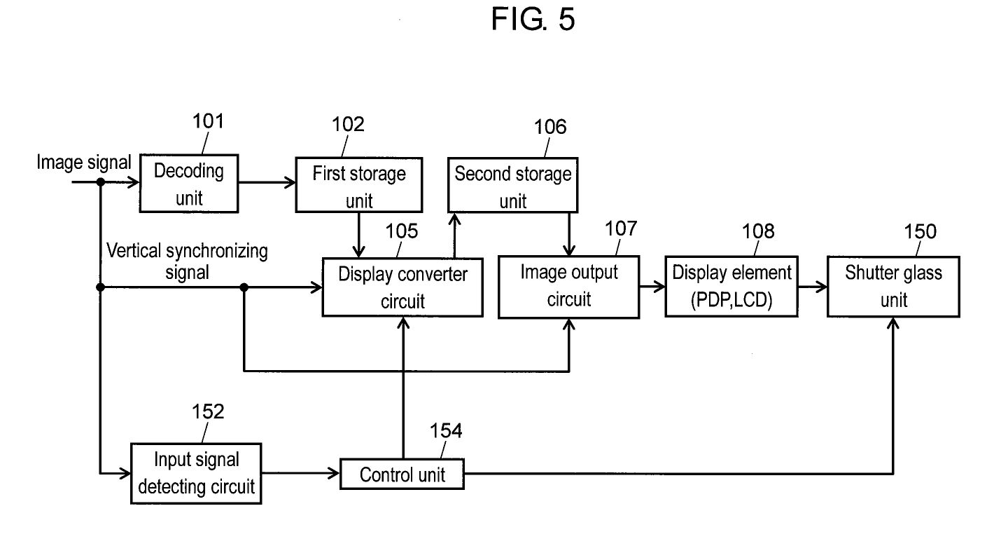

The pixel display device according to the present embodiment receives a normal image signal, but may alternatively receive a stereoscopic image signal. FIG. 5 is a circuit block diagram of another pixel display device according to the first embodiment of the present invention. The pixel display device of FIG. 5 differs from the pixel display device of FIG. 1 in further including shutter glass unit 150.

In this device, the image signal is a stereoscopic image signal having an image for the left eye and an image for the right eye. In the following description, operations common to the pixel display devices of FIGS. 1 and 5 will be sometimes omitted.

In the pixel display device of FIG. 5, input signal detecting circuit 152 receives a stereoscopic image signal and outputs a switching signal to control unit 154. The switching signal indicates the timing of switching between the image for the left eye and the image for the right eye.

Control unit 154 controls shutter glass unit 150 based on the switching signal.

Shutter glass unit 150 is connected to control unit 154 either wired or wirelessly. Control unit 154 controls shutter glass unit 150 synchronously with the switching between the image for the left eye and the image for the right eye. More specifically, control unit 154 controls shutter glass unit 150 to switch between the image for the left eye and the image for the right eye so that viewer 402 views only the image for the left eye by the left eye and only the image for the right eye by the right eye. For this purpose, shutter glass unit 150 includes a left-eye shutter and a right-eye shutter. These shutters are switched under the control of control unit 154 synchronously with the switching between the image for the left eye and the image for the right eye.

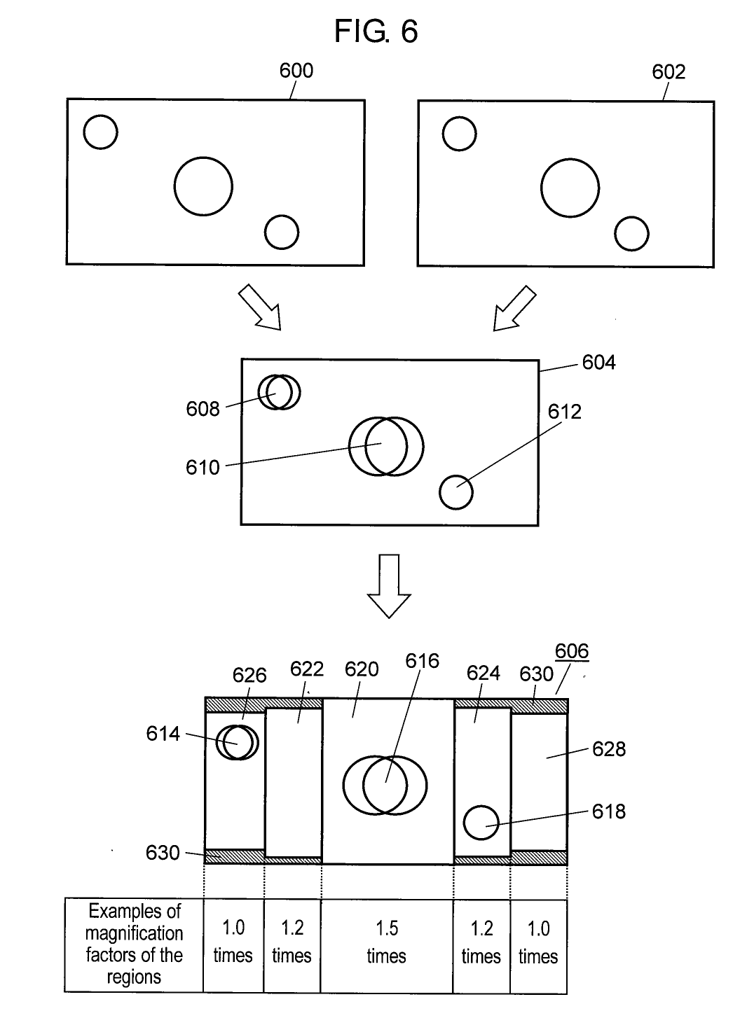

FIG. 6 is a conceptual view of an example showing the procedure for processing a stereoscopic image signal inputted to the pixel display device of FIG. 5 according to the present embodiment. As shown in FIG. 6, the stereoscopic image signal inputted to decoding unit 101 of the pixel display device includes image-for-the-left-eye 600 and image-for-the-right-eye 602, which are transmitted by, for example, a field sequential method. More specifically, image-for-the-left-eye 600 and image-for-the-right-eye 602 are images of the same object taken with two cameras from different positions. These images are transmitted alternately in time.

When viewing image-for-the-left-eye 600 and image-for-the-right-eye 602 without using shutter glass unit 150, viewer 402 recognizes image 604 which is a superimposition of image-for-the-left-eye 600 and image-for-the-right-eye 602.

When viewing image-for-the-left-eye 600 and image-for-the-right-eye 602 through shutter glass unit 150, on the other hand, viewer 402 feels that circular object 608 is close to him/her and is projecting from the screen of display element 108 because there is a displacement between image-for-the-left-eye 600 and image-for-the-right-eye 602. Viewer 402 also feels that circular object 610 is closer to him/her than object 608 because there is a larger displacement between image-for-the-left-eye 600 and image-for-the-right-eye 602. Viewer 402 also feels that circular object 612 looks the same as seen using shutter glass unit 150 because there is no displacement between image-for-the-left-eye 600 and image-for-the-right-eye 602. This image transmission method and the user of shutter glass unit 150 achieve viewing images stereoscopically.

When a stereoscopic image signal as described above is inputted to the pixel display device of FIG. 5, display element 108 receives image 606 in which regions closer to the center of the screen are shown in larger magnification. Below image 606 there is an example of magnification factors of the divided regions. In this example, region 620 in the center of the image has a magnification factor of 1.5; regions 622 and 624 on both sides of region 620 have a magnification factor of 1.2; and regions 626 and 628 at the right and left ends of the image have a magnification factor of 1.0.

Under these conditions, region 620 in the center of the image contains object 616 having a magnification factor of as large as 1.5. As a result, in the eyes of viewer 402, object 616 looks more projecting from the screen of display element 108 than circular object 608 contained in image 604, which is described above.

On the other hand, region 626 contains, at one end of the image, object 614 having a magnification factor of 1.0, indicating no magnification. Therefore, in the eyes of viewer 402, object 614 is viewed stereoscopically and looks projecting from the screen of display element 108 although object 614 looks less projecting than object 616.

Region 624 contains object 618, which has a magnification factor of 1.2. Object 618, however, does not look projecting from the screen of display element 108 because there is no displacement between image-for-the-left-eye 600 and image-for-the-right-eye 602.

Display converter circuit 105 under the control of control unit 104 initializes second storage unit 106 by storing black image data indicating the absence of images therein before subjecting the image outputted from display element 108 to an enlarging process. This allows display converter circuit 105 to display region 630 containing no images as black images by the enlarging process, making the boundary between regions which have been enlarged and displayed in image 606 almost invisible.

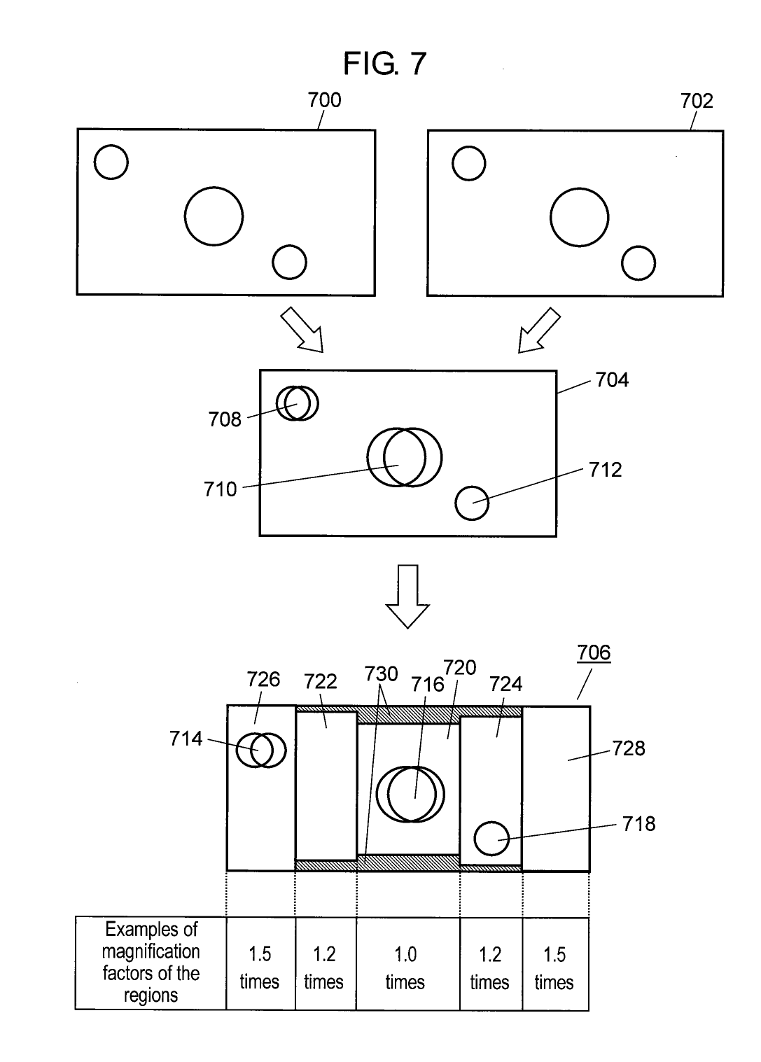

FIG. 7 is a conceptual view of another example showing the procedure for processing a stereoscopic image signal inputted to the pixel display device of FIG. 5 according to the first embodiment. As shown in FIG. 7, the stereoscopic image signal inputted to decoding unit 101 of the pixel display device includes image-for-the-left-eye 700 and image-for-the-right-eye 702, which are transmitted by, for example, a field sequential method. When viewing image-for-the-left-eye 700 and image-for-the-right-eye 702 without using shutter glass unit 150, viewer 402 recognizes image 704 which is a superimposition of image-for-the-left-eye 700 and image-for-the-right-eye 702.

When viewing image-for-the-left-eye 700 and image-for-the-right-eye 702 through shutter glass unit 150, on the other hand, viewer 402 feels that circular object 708 is close to him/her and is projecting from the screen of display element 108 because there is a displacement between image-for-the-left-eye 700 and image-for-the-right-eye 702. Viewer 402 also feels that circular object 710 is closer to him/her than object 708 because there is a larger displacement between image-for-the-left-eye 700 and image-for-the-right-eye 702. Viewer 402 also feels that circular object 712 looks the same as seen using shutter glass unit 150 because there is no displacement between image-for-the-left-eye 700 and image-for-the-right-eye 702. This image transmission method and the user of shutter glass unit 150 achieve viewing images stereoscopically.

When a stereoscopic image signal as described above is inputted to the pixel display device of FIG. 5, display element 108 receives image 706 in which regions closer to the right and left ends of the screen are shown in larger magnification. Below image 706, there is an example of magnification factors of the divided regions. In this example, region 720 in the center of the image has a magnification factor of 1.0; regions 722 and 724 on both sides of region 720 have a magnification factor of 1.2; and regions 726 and 728 at the right and left ends of the image have a magnification factor of 1.5.

Under these conditions, region 726 at one end of the image contains object 714 having a magnification factor of 1.5. As a result, in the eyes of viewer 402, object 714 looks more projecting from the screen of display element 108 than circular object 710 contained in image 704, which is described above.

Region 724 contains object 718, which has a magnification factor of 1.2 but does not look projecting from the screen of display element 108 because there is no displacement between image-for-the-left-eye 700 and image-for-the-right-eye 702.

On the other hand, region 720 contains, in the center of the image, object 716 having a magnification factor of 1.0, indicating no magnification. Therefore, in the eyes of viewer 402, object 716 is viewed stereoscopically and looks projecting from the screen of display element 108 although 716 looks less projecting than object 714.

Display converter circuit 105 under the control of control unit 104 initializes second storage unit 106 by storing black image data indicating the absence of images therein before subjecting the image outputted form display element 108 to an enlarging process. This allows display converter circuit 105 to display region 730 containing no images as black images by the enlarging process, making the boundary between regions which have been enlarged and displayed in image 706 almost invisible.

When second storage unit 106 is initialized before controlling the enlarging process of an image, the absence of images is indicated by black image data, but may be indicated by image data having other predetermined color tones. The predetermined color tones may form a background contained in the image, or may be composed of a specific single color, making the boundary between regions which have been enlarged in the image almost invisible.

As described hereinbefore, the pixel display device of FIG. 5 according to the present embodiment includes a shutter glass unit. The shutter glass unit receives an image signal including a stereoscopic image for the left eye and a stereoscopic image for the right eye, and whose left-eye and right-eye shutters are controlled by the control unit synchronously with the switching between the image for the left eye and the image for the right eye. This allows the pixel display device of FIG. 5 to provide images having a more three-dimensional appearance and a higher sense of presence by subjecting a stereoscopic image signal to an enlarging process.

### Second Embodiment

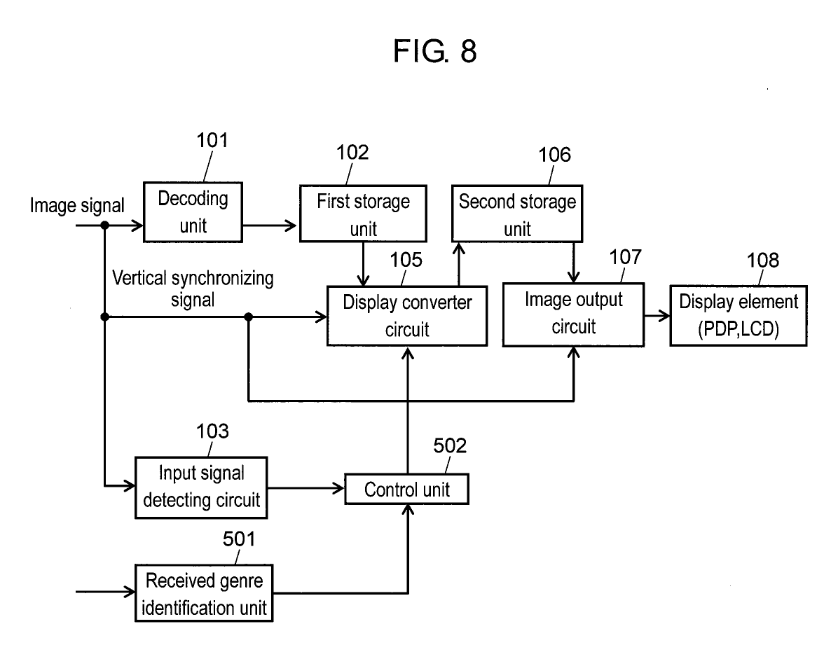

FIG. 8 is a circuit block diagram of a pixel display device according to a second embodiment of the present invention. The pixel display device includes decoding unit 101, first storage unit 102, input signal detecting circuit 103, received genre identification unit 501, control unit 502, display converter circuit 105, second storage unit 106, image output circuit 107, and display element 108. The pixel display device according to the present embodiment differs from the device of FIG. 1 according to the first embodiment in including received genre identification unit 501. In FIG. 8, like components are labeled with like reference numerals with respect to the device of FIG. 1, and hence the description thereof will be omitted.

Received genre identification unit 501 identifies the genre of a viewing program indicated by a received image signal. More specifically, received genre identification unit 501 receives the genre information of a received image signal through broadcasting or communication, performs a process of identifying the genre based on the obtained genre information, and transmits the genre information to control unit 502. Control unit 502 determines horizontal/vertical magnification information corresponding to the image signal according to a signal outputted from received genre identification unit 501. The genre information refers to information indicating the genre of the program such as music, movie, and news.

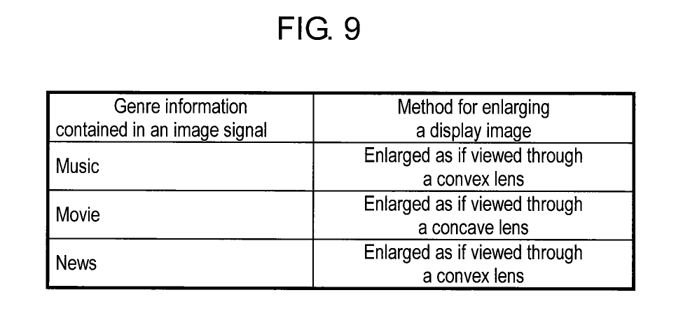

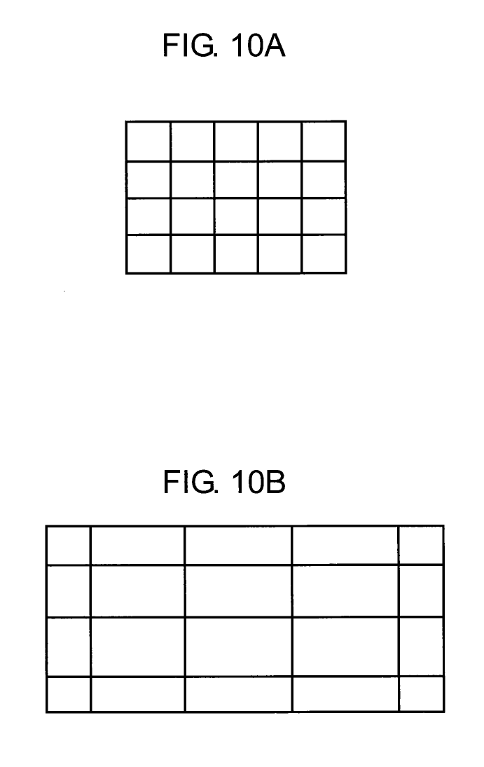

Control unit 502 has the function of associating methods for enlarging a display image with the genre information of an image signal in addition to the functions of control unit 104 described in detail in the first embodiment. Control unit 502 associates the methods for enlarging a display image with the genres of an image signal for example as shown in FIG. 9, and then determines horizontal/vertical magnification information based on the association.

With this structure, in order to identify the genre of an image in television broadcast service, received genre identification unit 501 identifies the genre of the image signal based on TV program information in EPG (electronic program guide) data or the like obtained through broadcasting or communication.

Control unit 502 then controls display converter circuit 105 according to the genre of the image identified by received genre identification unit 501. For example, when the genre of the image signal is music, the image is displayed as if it were viewed through a convex lens as shown in FIG. 3. This is because a music image contains a number of scenes of musicians playing instruments and viewer 402 is likely to want to feel close to the musicians. Therefore, it is preferable that control unit 502 controls display converter circuit 105 in such a manner as to enlarge the center of the display image.

When the genre of the image signal is news, control unit 502 may control display converter circuit 105 also in such a manner that the image is displayed as if it were viewed through a convex lens.

When the genre of the image signal is movie, on the other hand, control unit 502 controls display converter circuit 105 in such a manner that the image is displayed as if it were viewed through a concave lens as shown in FIG. 4. This is because viewer 402 is likely to want to feel as if he/she were experiencing the scene. Therefore, it is preferable that control unit 502 controls display converter circuit 105 in such a manner as to enlarge the edges of the display image and hence make viewer 402 feel enveloped in the world of that movie.

Thus, control unit 502 switches the display mode based on the identification result of received genre identification unit 501 in such a manner as to display image according to its genre.

As described above, when the genre of the image signal is music, the display image is enlarged as if the image were viewed through a convex lens as shown in FIG. 3. When the genre is movie, the display image is enlarged as if the image were viewed through a concave lens as shown in FIG. 4. Alternatively, however, viewer 402 can choose to view a music image as if it were viewed through a concave lens or to view a movie image as if it were viewed through a convex lens. Viewer 402 can also choose the type of the screen on which an enlarged image is displayed according to the genre of the image. The choices of viewer 402 can be performed with a remote control (not illustrated).

The type of the genre of an image other than TV images can be identified as follows. When an image is horizontally long and contains black belts on the top and bottom thereof and a region no less than a specified size, it is identified as a movie from the pixel information of the image. The specified size can be an aspect ratio of 16:9, for example. When the pixel information of the image shows that there is a specified difference in luminance between the edges and the center of the image, it is considered to be due to a spotlight in the center of the image, allowing the genre to be identified as music.

What is claimed is:

1. A pixel display device for displaying an image signal after converting an aspect ratio thereof, comprising,
a decoding unit for decoding the image signal;
a first storage unit for storing the image signal decoded;
a second storage unit for storing the image signal whose aspect ratio has been converted; and
a control unit for initializing the second storage unit by storing image data having a predetermined color tone therein;
dividing the image signal stored in the first storage unit into a predetermined number of regions, the predetermined number corresponding to the number of display pixels of a display screen;
subjecting the image signal stored in the first storage unit to an enlarging process from region to region, based on horizontal/vertical magnification information indicating different magnification factors of different divided regions in at least one of horizontal and vertical directions; and
storing the image signal subjected to the enlarging process from region to region in corresponding regions of the second storage unit.

2. The pixel display device of claim 1, further comprising:
a received genre identification unit for identifying a genre of the image signal, wherein
the control unit determines the horizontal/vertical magnification information corresponding to the image signal according to a signal outputted from the received genre identification unit.

3. The pixel display device of claim 1, further comprising:
a shutter glass unit, wherein
the image signal is a stereoscopic image signal having an image for the left eye and an image for the right eye, and
the shutter glass unit is controlled by the control unit synchronously with switching between the image for the left eye and the image for the right eye.

4. The pixel display device of claim 1, wherein
the horizontal/vertical magnification information is information to enlarge the image signal in a form of one of a convex lens and a concave lens.

5. The pixel display device of claim 1, wherein
the predetermined color tone is a specific single color.

6. The pixel display device of claim 1, wherein
the number of dividing regions is determined so that an amount of change in magnification factors of adjacent regions is not more than a predetermined value.
